(19) United States
(12) Patent Application Publication
(10) Pub. No.: US 2007/0096349 A1
(43) Pub. Date: May 3, 2007

(54) Heat-treated resin moldings and heat-treating apparatus for same

(75) Inventors: Kunihiro Kakihara, Hiroshima (JP); Yoshinori Noda, Hiroshima (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KAKIHARA KOGYO CO., LTD., Fukuyama-shi (JP)

(21) Appl. No.: 10/562,007

(22) PCT Filed: May 12, 2005
(86) PCT No.: PCT/JP05/08683

§ 371 Date: Dec. 23, 2005

(51) Int. Cl. B29D 11/00

(52) U.S. Cl. 264/1.1

(57) ABSTRACT

The occurrence of an undesirable phenomenon of a surface resin in a resin molding caused for example by peeling of a thin surface film of the resin molding is suppressed by subjecting the resin molding to a simple additional process. A resin molding heat-treating apparatus according to the present invention is for heat-treating partially at a high temperature a parting line portion W1 of a resin molding W or a specific portion of the resin molding W which portion is apt to undergo peeling of a thin surface resin film, the apparatus comprising a heating section 2 of a shape conforming to a contour line of a portion to be heated of the resin molding W and a fixing jig 4 for fixing the resin molding W removably, the portion to be heated of the resin molding W being heat-treated at a high temperature while being approximated to the heating section 2.

### TECHNICAL FIELD

The present invention relates to a technique for producing resin moldings. Particularly, the present invention is concerned with heat-treated resin moldings able to prevent a peeling phenomenon of a thin surface film of a molding material which occurs in the resin moldings, as well as a heat-treating apparatus for the same.

### BACKGROUND ART

The number of accidents is increasing with respect to resin moldings which have heretofore been available on the market. For example, as shown in FIG. 9, in the case of a handle 51 made of resin, a parting line 52 is formed in a joint portion at the time of molding, and injury accidents of fingers being cut by the parting line 52 have occurred. Particularly, in the case of plated resin moldings plated with resin, a lot of injury accidents have occurred.

Moreover, accidents have occurred in the case of resin moldings or plated resin moldings which are frequently handled directly by hand such as products used as substitutes for washing metal fittings, e.g., faucets and shower parts in bathrooms, and automobile parts, e.g., radiator grille, door opening/closing handles and interior decorative parts. In these resin moldings there has occurred an injury accident such that a resin-plated film floats and a hand is cut by the resulting sharp portion. For example, as shown in FIG. 10, a thin film ply separation in a resin molding of this type sometimes occurs in the case of a resin which is apt to form a layered structure during molding such as PP resin or in the case of a resin molding using a characteristic-reinforced material called polymer alloy in which two or more kinds of resin materials are mixed together. This was made sure when there was conducted a thermal shock test to be described later or a thermal cycle test with respect to resin-plated products obtained by using PC/ABS (polycarbonate-ABS) resin or ABS resin. Further, when viewed from the standpoint of molding conditions for resin moldings, the thin film ply separation in question tends to occur more frequently when the injection speed is high or when the amount of a low boiling fraction gas from resin is large. The state of occurrence of this phenomenon differs also depending on the shape of product or the structure of a mold used.

FIGS. 11 to 13 are photographs of a resin surface of a resin molding taken through a transmission electron microscope (TEM).

With respect to a resin molding obtained under the same conditions as those adopted for a product which underwent ply separation when there was conducted such a strong thermal shock test as illustrated, the present inventor checked a state of deformation of the resin surface with use of photographs taken through a transmission electron microscope (TEM).

FIG. 11 is a photograph showing the state of a cavity surface (a front surface) of a resin molding. In the same figure, a circular or black dot-like portion represents a rubber component contained in resin. In this resin molding, the rubber component is uniformly dispersed in a circular shape in the resin surface of the cavity surface and a molding stress in the resin surface is reduced.

FIG. 12 is a photograph showing the state of a parting portion (the center and the vicinity thereof) of the resin molding. In this state of the resin molding, as compared with the cavity surface shown in FIG. 11, the rubber component in the surface resin layer is stretched like a bamboo leaf and is in a layered form. Deformation is found also in the rubber component located in a lower portion of the section and there is a residue of a molding stress.

FIG. 13 is a photograph showing the state of a parting portion (a front end) of the resin molding. In this state, the rubber component in the resin surface layer is deformed to a greater extent than the parting portion shown in FIG. 11. Further, the proportion of the rubber component located in a lower portion of the section is smaller than that of the parting portion shown in FIG. 12 and the dispersion thereof is sparse.

Such a concentration of the molding stress on the parting portion is presumed to be a cause of thin film ply separation in the surface resin layer in a state of excess heat history of the resin molding. Thus, according to the phenomenon in question, the thin resin film undergoes ply separation due to heat history applied to the resin molding. That is, the ply separation of the resin molding is attributable to the resin molding or feed resin itself which is unavoidable in the resin molding manufacturing process.

In many cases, the phenomenon in question is caused by peeling of a thin surface resin film of the resin molding which occurs when the resin molding is exposed to a specific environment involving, for example, high and low temperatures and repetition thereof. Various techniques have been proposed for avoiding such an undesirable phenomenon which occurs on the resin molding surface. For example, for avoiding the undesirable phenomenon occurring on the resin molding surface in the resin molding manufacturing stage, there has been proposed a burr processing method for burr formed on the surface of a resin molding. For example, this method is proposed as “Burr Processing Method and Apparatus” in Japanese Patent Laid Open No. 2002-240050 (Patent Literature 1), in which a burr formed on the surface of a resin molding is processed. This burr processing method comprises a heating step of heating a jig having a pressing surface parallel to a resin surface to raise the temperature of the pressing surface to a predetermined temperature and a pressing step of pressing the pressing surface of the predetermined temperature toward the resin surface from a state of contact with a burr.

Patent Literature 1:

Japanese Patent Laid Open No. 2002-240050

According to this conventional burr processing method, since the burr is heat-deformed and is fixed to the resin surface, the drop of the burr from the resin molding can be prevented without producing any cut waste of the burr. Besides, since the pressing surface is parallel to the resin surface, the burr is deformed so as to spread in a thin-walled state on the resin surface. Consequently, the burr can be make thin to an ignorable extent and it is possible to minimize the obstruction of the burr to the function of the resin molding.

### DISCLOSURE OF THE INVENTION

### PROBLEMS TO BE SOLVED BY THE INVENTION

However, the above conventional burr processing method involves the problem that when the resin molding having gone through the same method is touched actually by hand, the hand feels a sense of incongruity because a slight uneven surface remains in the resin molding.

Particularly, when the resin molding is plated with resin, fine convexes and concaves are apt to occur on the plated surface and cause peeling of the plated surface.

With this burr processing method, it has been impossible to remedy the surface resin peeling phenomenon of the resin molding.

The present invention has been accomplished for solving the above-mentioned problems. That is, it is an object of the present invention to provide a resin molding having gone through a simple additional heat-treating process and thereby suppress the occurrence of an undesirable phenomenon of a surface resin due to peeling of a thin surface film of the resin molding by simply adding a processing step to the resin molding, as well as a heat-treating apparatus for the resin molding.

### MEANS FOR SOLVING THE PROBLEMS

According to the present invention there is provided a heat-treated resin molding obtained by heat-treating a resin molding (W) partially at a high temperature, the resin molding (W) being produced by molding with use of a mold.

The resin molding (W) is a molding to be subjected to plating with resin. In the resin molding (W), a parting line portion (W1) thereof is heat-treated at a high temperature. Moreover, in the resin molding (W), a specific portion thereof which is apt to undergo peeling of a thin surface resin film is heat-treated at a high temperature.

Preferably, the resin molding (W) is heat-treated at a high temperature so that rubber particles in the resin surface of the resin molding retain a generally circular shape.

Preferably, the resin molding (W) is heat-treated at a high temperature so that rubber particles in the resin surface of the resin molding retain a circular shape of 2:3 or less in terms of a size ratio in longitudinal and transverse directions.

The resin molding (W) to be partially heat-treated at a high temperature may be a resin molding produced by molding in an injection molding machine.

According to the present invention there also is provided a heat-treating apparatus (1) for heat-treating a parting line portion (W1) of the resin molding (W) or a specific portion of the resin molding (W) which portion is apt to undergo peeling of a thin surface resin film partially at a high temperature, the apparatus (1) comprising a heating section (2) having a shape conforming a contour line of a portion to be heated of the resin molding (W) and a fixing jig (4) for fixing the resin molding (W) removably, wherein the portion to be heated of the resin molding (W) is heat-treated at a high temperature while being approximated to the heating section (2).

The fixing jig (4) is attached to several positions of a rotary disc (3) and the portion to be heated of the resin molding (W) projects from the peripheral edge of the rotary disc (3) so as to pass through a heat-treating space (S) formed in the heating section (2).

There is disposed a shield plate (8) having an opening portion (7) of a shape conforming to the contour line of the portion to be heated of the resin molding (W) is disposed in a sandwiching relation to the heating section (2) so that the other portion than the portion to be heated of the resin molding (W) is not heated.

There may be adopted a construction wherein the fixing jig (4) is attached to several positions of a side edge of a belt member and the portion to be heated of the resin molding (W) projects from the belt member so as to pass through a heat-treating space (S) formed in the heating section (2).

The heating section (2) is constructed such that a large number of fine holes are formed in a pipe which is analogous to the contour line of the resin molding (W) and which is bent so as to be in a shape about twice as large as the resin molding (W), and hot air is ejected through the fine holes to heat the resin molding.

The heating section (2) may be constructed such that a member analogous to the contour line of the resin molding (W) and having a shape about twice as large as the resin molding (W) is heated by an electromagnetic induction heating method.

The heating section (2) may be constructed such that a member analogous to the contour line of the resin molding (W) and having a shape about twice as large as the resin molding (W) is heated by a high-frequency heating method.

### EFFECT OF THE INVENTION

In the resin molding (W) of the above construction, a residual stress remaining in the resin molding (W) can be relaxed by heat-treating the resin molding partially. Consequently, it is possible to prevent floating of a thin surface film of the resin molding (W). Particularly, the resin molding (W) can be heat-treated in a short time without heating a portion of the molding resin which portion is apt to become uneven or deformed. Since the resin molding (W) can be heat-treated instantaneously even at a high temperature as high as 120° C. or more, the residual stress can be relaxed partially and positively.

With the heat-treating apparatus (1) of the above construction, the resin molding (W) can be heat-treated in a short time without heating a portion of the resin molding which portion is apt to become uneven or deformed. Since the resin molding (W) can be heat-treated instantaneously even at such a high temperature as 120° C. or more, it is possible to relax the residual stress partially and positively.

### BRIEF DESCRIPTION OF THE DRAWINGS

FIG. 1 is an enlarged sectional side view of a heating section of a resin molding heat-treating apparatus according to the present invention;

FIG. 2 is an enlarged side view of the heating section;

FIG. 3 is an overall plan view of the resin molding heat-treating apparatus;

FIG. 4 is an enlarged side view of the heating section of the resin molding heat-treating apparatus;

FIGS. 5(a) to 5(c) show the results of having actually measured temperatures applied to various portions of the resin molding with use of a thermoelectric thermometer, in which FIG. 5(a) is an explanatory diagram showing various potions of the resin molding, FIG. 5(b) is a table of first measurement results and FIG. 5(c) is a table of second measurement results;

FIG. 6 shows experimental results in plating and comparison made by a thermal shock test, comprising a table showing experimental results on resin moldings without heat treatment and a table showing experimental results on resin moldings after heat treatment;

FIG. 7 is a photograph showing the state of a parting portion (the center and the vicinity) of a resin molding;

FIG. 8 is a photograph showing the state of a parting portion (a front end) of the resin molding;

FIG. 9 is a front view of a synthetic resin handle formed by a conventional resin molding method, with a parting line formed in a joint portion;

FIG. 10 is an enlarged photograph of a surface of a resin-plated resin molding in a state in which a “thin film ply separation” has occurred from a parting portion;

FIG. 11 is a photograph showing the state of a cavity surface (a front surface) of a resin molding;

FIG. 12 is a photograph showing the state of a parting portion (the center and the vicinity) of the resin molding; and

FIG. 13 is a photograph showing the state of a parting portion (a front end) of the resin molding.

### EXPLANATION OF REFERENCE NUMERALS

1 heat-treating apparatus

2 heating section

4 fixing jig

3 rotary disc

7 opening portion

8 shield plate

W resin molding

W1 parting line portion

S heat-treating space

### BEST MODE FOR CARRYING OUT THE INVENTION

A preferred embodiment of the present invention will be described below with reference to the drawings.

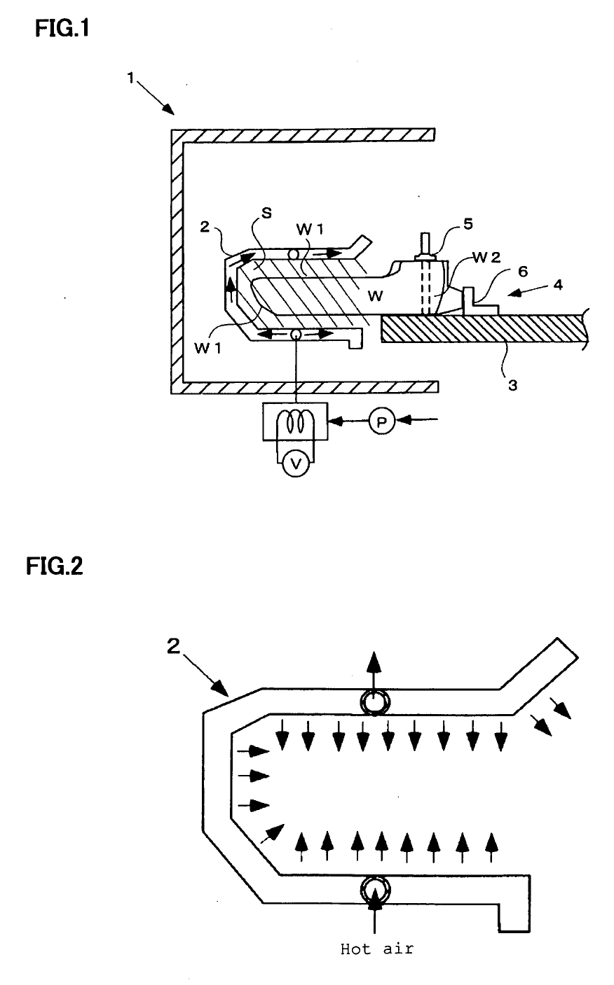

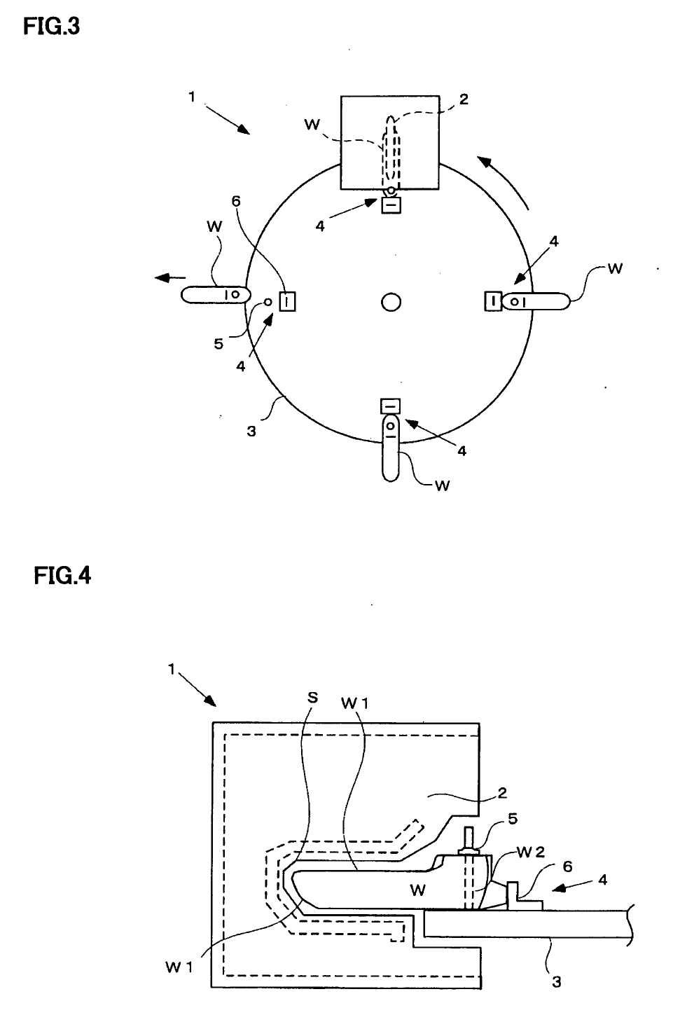

FIG. 1 is an enlarged sectional side view of a heating section of a resin molding heat-treating apparatus according to the present invention. FIG. 2 is an enlarged side view of the heating section. FIG. 3 is an entire plan view of the resin molding heat-treating apparatus. FIG. 4 is an enlarged side view of the resin molding heat-treating apparatus.

The heat-treated resin molding according to the present invention is obtained by heat-treating at a high temperature a parting line portion W1 of a resin molding W after molding in a mold or after injection molding or a specific portion of the resin molding W which portion is apt to undergo peeling of a thin surface resin film of the resin molding.

As the material of the resin molding W in the present invention there may be used any of all the materials used in the production of resin-plated parts, including ABS resin, PC/ABS resin (polycarbonate/ABS resin), PC/PET resin (polycarbonate/polyethylene terephthalate resin), PC/PBT resin (polycarbonate/polybutylene terephthalate resin), PC resin, PA resin (polyamide resin), POM resin (polyoxymethylene resin), PPE resin (polyphenylene ether resin), LCP resin (liquid crystalline polymer resin), PPS resin (polyphenylene sulfide resin), PS resin (polystyrene resin), and SPS resin (syndiotactic polystyrene resin). No limitation is made thereto. An appropriate heat treatment temperature differs depending on the resin material used. As noted in the foregoing paragraph of background art, the present invention is suitable for a resin molding W comprising two or more different resins and containing a rubbery or oil- or fat-like substance which is apt to appear in the resin molding W.

Next, a description will be given about the resin molding heat-treating apparatus with reference to FIGS. 1 to 4.

In the heat-treating apparatus, indicated at 1, for the resin molding W according to the present invention, in order to heat the resin molding W partially at a high temperature, a parting line portion W1 of the resin molding W or a specific portion of the resin molding W which portion is apt to undergo peeling of a thin surface resin film is passed through the interior of a heat-treating space S in a heating section 2 of the heat-treating apparatus 1, i.e., a hatched area in FIG. 1, and is thereby heat-treated at a high temperature. The resin molding W shown in FIG. 1 is a door handle of an automobile and a portion (approximately half of the left side in the figure) to be grasped by man is heated concentratively, while the other portion is kept away from the heating section 2. This is because the heat treatment should not cover the portion of the resin molding W which portion is apt to become uneven or deformed although in the present invention a residual stress on the resin molding W is to be relaxed.

As shown in the plan view of FIG. 3, fixing jigs 4 for resin moldings W are arranged in plural positions of a rotary disc 3 and the resin moldings W are respectively fixed partially thereby. In the case where each resin molding W has a shaft mounting hole W2 like a door handle, each of the illustrated fixing jigs 4 comprises a fixing pin 5 to be inserted into the shaft mounting hole W2 and a stopper 6 for holding the portion of the shaft mounting hole W2. It goes without saying that the construction of each fixing jig 4 changes in accordance with the shape and size of each resin molding W.

The rotary disc 3 with plural resin moldings W thus fixed thereto is heat-treated while being passed through the interior of the heat-treating space S in the heating section 2 of the heat-treating apparatus 1. The thus heat-treated resin moldings W are removed from the fixing jigs 4 (on the left side of the rotary disc 3 shown in FIG. 2) and are replaced by untreated resin moldings W (on the lower side of the rotary disc 3 shown in FIG. 2). These operations are repeated.

As shown in FIGS. 1 and 2, the heating section 2 described above is analogous to a contour line of each resin molding W and is constructed such that a large number of fine holes are formed in a pipe of a shape about twice as large as the resin molding W and hot air is ejected through the fine holes toward the resin molding W. According to the shape of the heating section 2 illustrated in FIG. 1, such a heat-treating space S as can heat a grip portion of a door handle is formed and the portion of the shaft mounting hole W2 is not heated. It goes without saying that the shape of the heating section 2 is determined in accordance with the shape of the resin molding W.

In the heating section 2, however, no limitation is made to such a hot air heating method insofar as the heating means adopted can heat the resin molding W uniformly along the contour line of the resin molding. For example, there may be adopted steam heating, heater heating, high-frequency heating, flame heating, or electromagnetic induction heating. Any method can be adopted if only it can heat-treat the resin molding W.

For example, the heating section 2 may be constructed (not shown) such that a member analogous to the contour line of the resin molding W and having a shape about twice as large as the resin molding W is heated by an electromagnetic induction heating method or a high-frequency heating method.

As shown in the enlarged side view of FIG. 4, to prevent the other portion than the portion to be heated of the resin molding W from being heated, a shield plate 8 formed with an opening portion 7 of a shape conforming to a contour line of the portion to be heated of the resin molding W is disposed so as to sandwich the heating section 2 from both sides. With the shield plate 8, the portion of the resin molding W which portion is apt to become uneven or deformed is not heated.

Thus, the following effects can be obtained by the heat-treating apparatus 1 according to the present invention. The resin molding can heat-treated partially in a short time. The portion of the resin molding which is apt to become uneven or deformed in the resulting product can be left unheated. The resin molding can be heated at such a high temperature as 120° C. or more because the heating is done instantaneously, and hence a residual stress can be partially relaxed positively. Only the stress-remaining portion of the resin molding W can be treated.

It is preferable that the heat-treating temperature for the resin molding W be approximately within the range from the heat deformation temperature of resin to the resin molding temperature although it differs depending on the resin material used as described earlier. For example, in the case of a resin molding W made of ABS resin, heat treatment by the heat-treating apparatus 1 in a heating temperature range corresponding to a surface temperature of the resin molding W of 80° to 150° C. was found effective. In the case of a resin molding W made of PC/ABS resin, heat treatment by the heat-treating apparatus 1 in a heating temperature range corresponding to a surface temperature of the resin molding W of 100° to 200° C. was found effective. However, it is also possible to heat the resin molding W to 200° C. or higher, depending on the grade of the resin molding or molding conditions.

A suitable heat-treating time for the resin molding W is in the range from 1 second to 30 minutes, but no limitation is made thereto insofar as the heat-treating time adopted does not cause such a degree of heat deformation as no longer meets the requirement as product of the resin molding W. The heat-treating time is adjusted by adjusting the rotational speed of the rotary disc 3 of the heat-treating apparatus 1.

The heat-treating time for the resin molding W is determined according to the quantity of heat in the heating section 2 of the heat-treating apparatus 1 and the capacity of the resin molding W to be heated. For example, when heat-treating a small resin molding W at a high temperature, the heat-treating time may be a short time, while when heat-treating a large resin molding W at a low temperature, the heat-treating time is required to be a long time.

In the heat-treating apparatus 1 according to the present invention, by heat-treating the resin molding W partially, not only a residual stress remaining in the resin molding W can be relaxed, but also floating of a thin surface film of the resin molding W can be prevented. The thus heat-treated resin molding W is then plated with resin. For example, the resin molding W is subjected to a pretreatment such as etching treatment or reduction treatment, followed by catalyst treatment and subsequent chemical plating. Then, the resin molding W is further subjected to electroplating and finishing treatment to complete the resin plating. In the thus resin-plated resin molding W, it is possible to prevent the occurrence of such undesirable phenomena as blister and peeling of the plated film.

### EXAMPLE 1-1

Next, a description will be given below about experiment examples of heat-treated resin moldings according to the present invention.

Heat treatment was performed using a gas torch in such a manner that the gas torch was spaced a sufficient distance from a resin molding W to avoid melting of the resin of a parting outer periphery portion of the resin molding by direct flame.

### EXAMPLE 1-2

Hot air of 180-220° C. was blown off from a nozzle having a nose diameter of 5 mm against a parting portion of a resin molding while keeping the nozzle spaced about 10-5 mm from the parting portion. About 30 cm of the outer periphery of the parting portion was heat-treated for 20-40 seconds. A grip portion of the nozzle was fixed to a work bench, then the resin molding was attached to a working NC robot and was heat-treated automatically in accordance with a working program set to 20-40 seconds while keeping the resin molding spaced 10 mm from the nozzle.

### EXAMPLE 1-3

A copper pipe of about 7 mm was bent in conformity with a parting shape of product and was perforated to form 1.5 mm dia. holes at intervals of 5 mm toward a parting portion of a resin molding, thereby affording a hot air blow-off machine. With this machine, the resin molding was heat-treated by blowing off hot air for about 10-20 seconds.

Temperatures applied to the surfaces of various portions of the resin molding were measured using a thermoelectric thermometer, the results of which will be shown below.

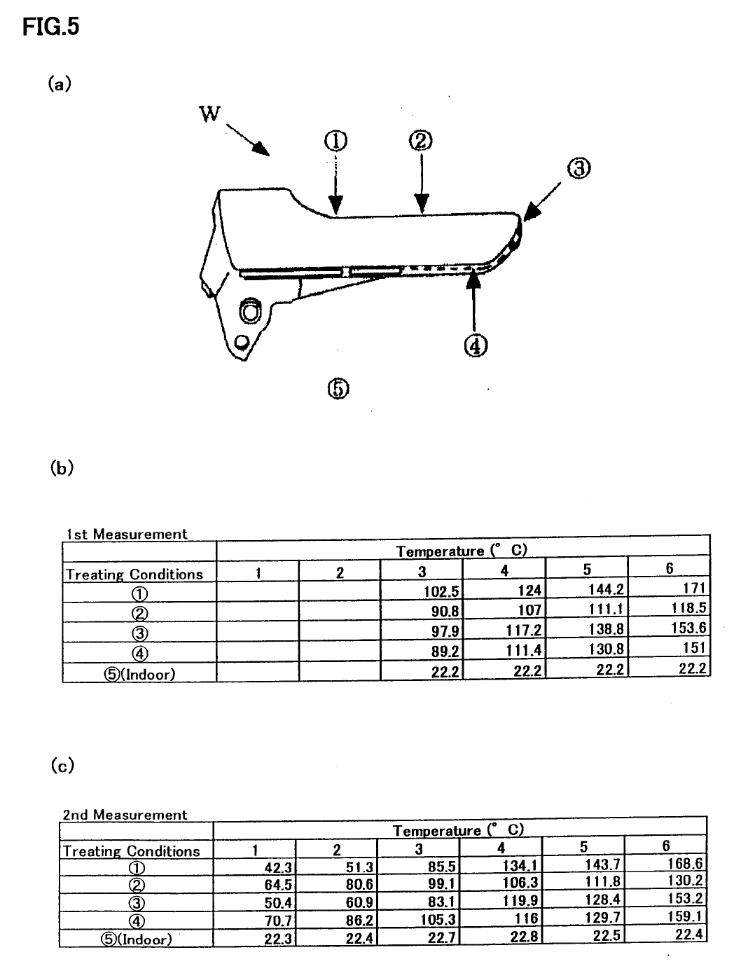

FIGS. 5(a) to 5(c) show the results of having measured temperatures applied to various portions of the resin molding, which measurement has been made using a thermoelectric thermometer. In the same figure, FIG. 5(a) is an explanatory diagram showing the various portions of the resin molding, FIG. 5(b) is a table showing the results of a first measurement, and FIG. 5(c) is a table showing the results of a second measurement.

### EXAMPLE 1-4

An electric heater was fabricated using the same shape as that of the hot air nozzle used in Example 1-3 and a resin molding was allowed to pass through the heater automatically. In this way there was produced for trial an apparatus able to heat-treat parting portions at a time. The heater temperature and the resin molding passing time (heat-treating time) through the heater can be changed. In this example, the resin molding was stopped for 20 seconds within the heater.

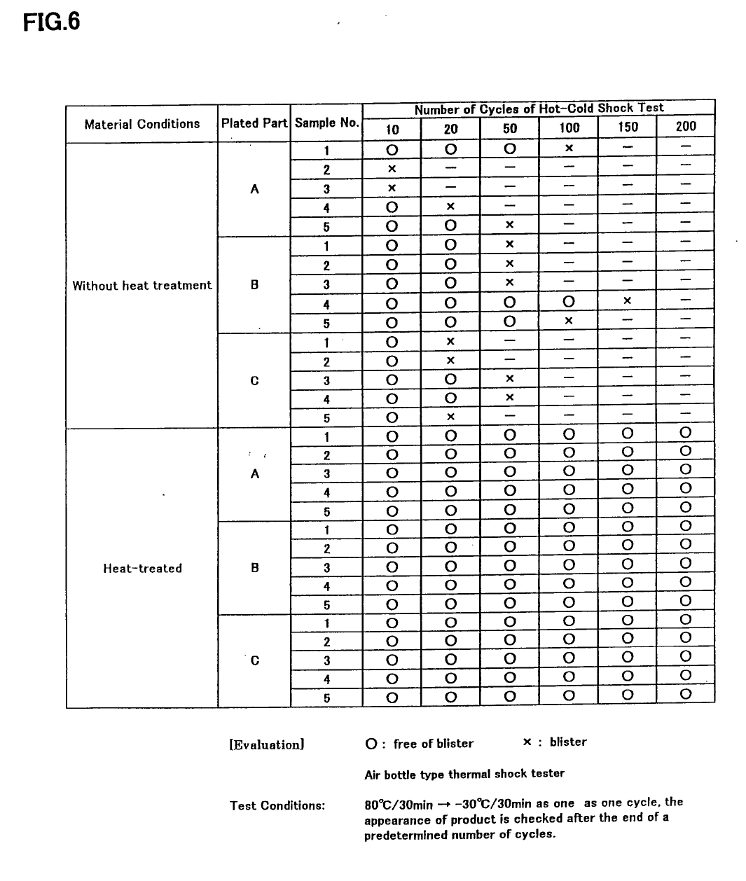

FIG. 6 shows experimental results in plating and comparison made by a thermal shock test, comprising a table showing experimental results on resin moldings without heat treatment and a table showing experimental results on resin moldings after heat treatment.

The resin moldings were subjected to a conventional plating treatment and then the occurrence of an undesirable phenomenon under defined thermal shock conditions was compared with respect to the treated resin moldings and untreated resin moldings. Although the resistance to the thermal shock test somewhat differs depending on treatment conditions and methods, the parting portions of all the heat-treated resin moldings passed the thermal shock test and an extinct difference from the untreated resin moldings was confirmed.

As is seen from the tables of FIG. 6 showing experimental results, by heat-treating parting portions and edge portions of resin moldings, which portions are apt to undergo ply separation, partially at a high temperature for a short period of time, deformations and stresses of rubber components in surface resin layers remaining in those positions are diminished, whereby ply separation of thin surface resin layers caused by an excess heat history in the resin moldings could be prevented. The resin moldings heat-treated by the heat-treating apparatus 1 according to the present invention exhibit a remarkable improvement of their resistance to the thermal shock test. By plating such resin moldings with resin, it is possible to prevent the occurrence of ply separation of a thin resin film and the simultaneous floating of the plating film both caused by the foregoing cause in a resin-plated part installed in an automobile and also possible to prevent the occurrence of a serious accident such as a driver or an occupant touching a cracked surface of a floated, plated portion and being cut his or her hand.

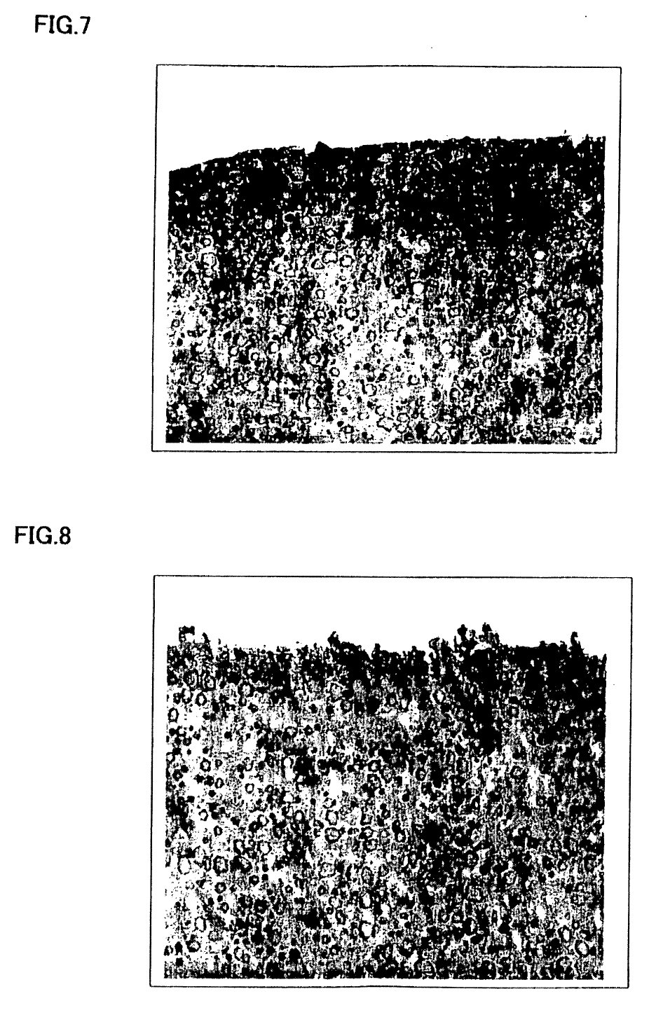

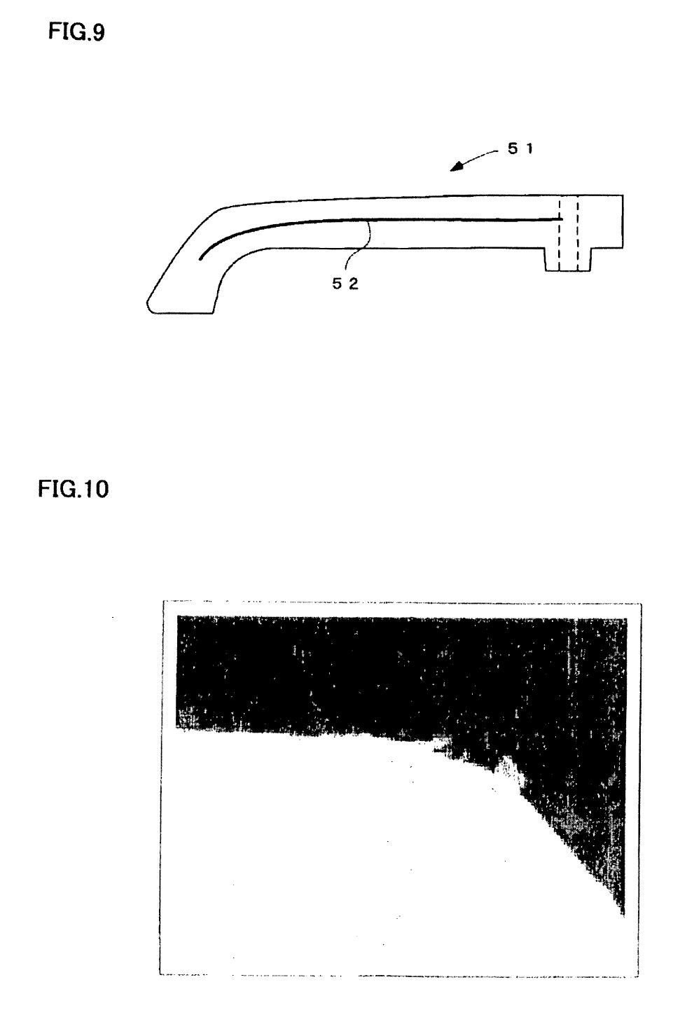

FIGS. 7 and 8 are photographs of resin surfaces taken through a transmission electron microscope (TEM), showing the effect of the partial heating for a parting portion of a resin molding heat-treated according to the present invention.

FIG. 7 is a photograph showing the state of a parting portion (the center and the vicinity) of the resin molding.

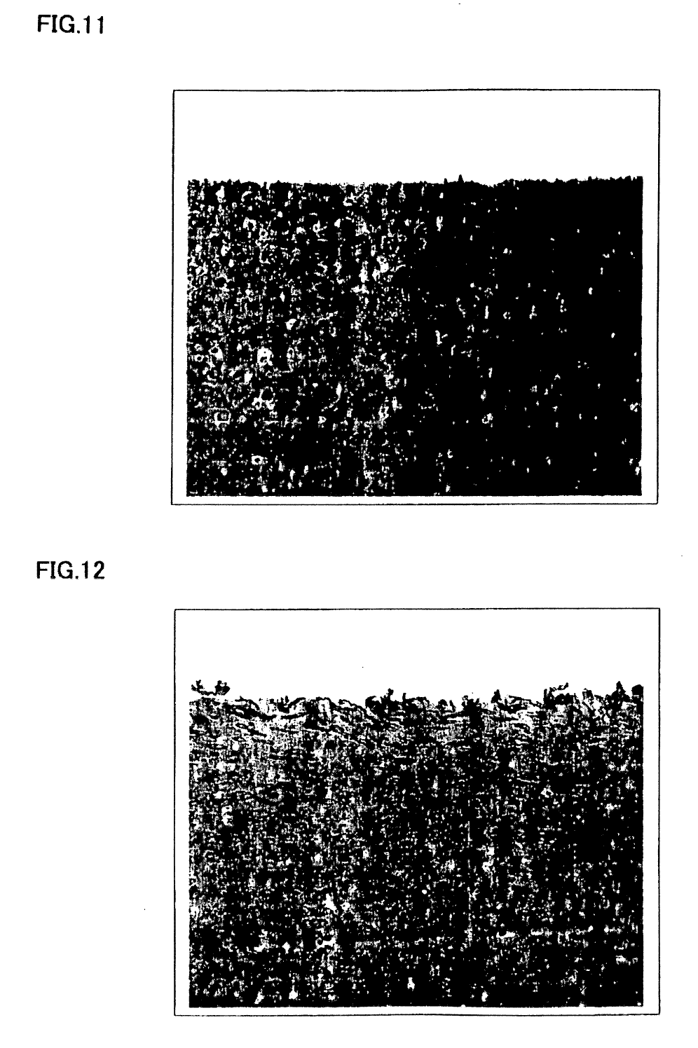

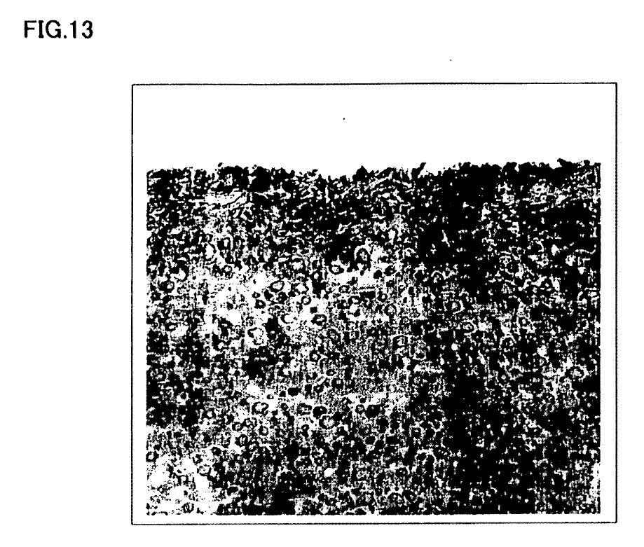

As a result of having heat-treated the parting portion of the resin molding W, a bamboo leaf-like rubber orientation in the surface resin layer disappeared. In the present invention, the resin molding W is subjected to a high-temperature heat treatment, whereby rubber particles in the resin surface are maintained in a generally circular shape. For example, it is preferable to perform the high-temperature heat treatment in such a manner that the rubber particles in the resin surface retain a circular shape of 2:3 or less in terms of a size ratio in longitudinal and transverse directions. This clearly shows a change in state as compared with the state of the resin molding before heat treatment referred to in the foregoing paragraph of background art and illustrated in FIGS. 11 to 13. The deformation of rubber component located in a lower portion of section is also remedied. That is, it is seen that the residue of the molding stress in the parting portion has been diminished by a partial heat-treatment for the parting portion. This means that the deformation diminishing effect for rubber particles in the resin molding W can be measured through a transmission electron microscope (TEM).

FIG. 8 is a photograph showing the state of a parting portion (a front end) of the resin molding.

Also in this case the deformation of rubber component in the surface resin layer is remedied. By a partial heat treatment for the parting portion of the resin molding W, it turned out that the molding stress imposed on the parting portion was relaxed and that the deformation of rubber component was remedied. As to variations in the dispersion of rubber component in the lower portion of section, it cannot be remedied. This means that the resin molding W according to the present invention has been heat-treated on only the surface side or partially for avoiding the occurrence of an undesirable phenomenon, e.g., blister, after resin-plating without changing the physical properties peculiar to the resin molding W.

The construction of the heat-treating apparatus 1, especially the structure of the rotary disc 3, is not limited to the one shown in FIG. 3. For example, there may be adopted a construction wherein the foregoing fixing jigs are attached to plural positions of the side edge of a belt member (not shown) and portions to be heated of resin moldings W are projected from the belt member so as to pass through the heat-treating space S formed in the heating section 2 of the heat-treating apparatus 1.

Also in this construction using the belt member, for preventing the other portion than the portion to be heated of the resin molding W from being heated, a shield plate 8 formed with an opening portion 7 of a shape conforming to the contour line of the portion to be heated of the resin molding W is disposed in the heating section 2 so as to sandwich the heating section from both sides, allowing the belt member to pass through the opening portion 7 together with the resin molding W.

It goes without saying that the present invention is not limited to the above embodiment, but that various changes may be made within the scope not departing from the gist of the present invention insofar as the heat-treating apparatus 1 involves a simple additional process for the resin molding W after the execution of molding with resin and can thereby prevent the occurrence of an undesirable phenomenon caused by floating of a thin surface film of the resin molding W.

### INDUSTRIAL APPLICABILITY

The heat-treated resin molding and the heat-treating apparatus therefor according to the present invention can be applied to door opening/closing handles or substitutes for washing metal fittings and further applicable to the treatment of resin-plated products which are frequently handled directly by hand such as, for example, electronic devices, e.g., personal computers, as well as game machines, instruments for maintaining health, and printing machines.

1. A heat-treated resin molding obtained by heat-treating a specific portion of a resin molding (W) partially at a high temperature which specific portion is apt to undergo peeling of a thin surface resin film of the resin molding (W), the resin molding (W) being produced by molding with use of a mold and to be subjected to plating with resin.

2. (canceled)

3. A heat-treated resin molding according to claim 1, wherein a parting line portion (W1) of the resin molding (W) is heat-treated at a high temperature.

4. (canceled)

5. A heat-treated resin molding according to claim 1, wherein the resin molding (W) is heat-treated at a high temperature so that rubber particles in the resin surface of the resin molding retain a generally circular shape.

6. A heat-treated resin molding according to claim 1, wherein the resin molding (W) is heat-treated so that rubber particles in the resin surface of the resin molding retain a circular shape of 2:3 or less in terms of a size ratio in longitudinal and transverse directions.

7. A heat-treated resin molding according to claim 1, wherein the resin molding (W) to be partially heat-treated at a high temperature is a resin molding produced by molding in an injection molding machine.

8. A resin molding heat-treating apparatus (1) for heat-treating a parting line portion (W1) of a resin molding (W) or a specific potion portion of the resin molding (W), which portion is apt to undergo peeling of a thin surface resin film, partially at a high temperature,
the apparatus (1) comprising:
heating section (2) having a shape conforming to a contour line of a portion to be heated of the resin molding (W); and
a fixing jig (4) for fixing the resin molding (W) removably,
wherein the portion to be heated of the resin molding (W) is heat-treated at a high temperature while being approximated to the heating section (2).

9. A resin molding heat-treating apparatus according to claim 8, wherein the fixing jig (4) is attached to several positions of a rotary disc (3) and the portion to be heated of the resin molding (W) projects from the peripheral edge of the rotary disc (3) so as to pass through a heat-treating space (S) formed in the heating section (2).

10. A resin molding heat-treating apparatus according to claim 8, wherein a shield plate (8) having an opening portion (7) of a shape conforming to the contour line of the portion to be heated of the resin molding (W) is disposed in a sandwiching relation to the heating section (2) so that the other portion than the portion to be heated of the resin molding (W) is not heated.

11. A resin molding heat-treating apparatus according to claim 8, wherein the fixing jig (4) is attached to several positions of a side edge of a belt member and the portion to be heated of the resin molding (W) projects from the belt member so as to pass through a heat-treating space (S) formed in the heating section (2).

12. A resin molding heat-treating apparatus according to claim 8, wherein the heating section (2) is constructed such that a large number of fine holes are formed in a pipe which is analogous to the contour line of the resin molding (W) and which is bent so as to be in a shape about twice as large as the resin molding (W), and hot air is ejected through the fine holes to heat the resin molding.

13. A resin molding heat-treating apparatus according to claim 8, wherein the heating section (2) is constructed such that a member analogous to the contour line of the resin molding (W) and having a shape about twice as large as the resin molding (W) is heated by an electromagnetic induction heating method.

14. A resin molding heat-treating apparatus according to claim 8, wherein the heating section (2) is constructed such that a member analogous to the contour line of the resin molding (W) and having a shape about twice as large as the resin molding (W) is heated by a high-frequency heating method.

15. A heat-treated resin molding according to claim 3, wherein the resin molding (W) is heat-treated at a high temperature so that rubber particles in the resin surface of the resin molding retain a generally circular shape.

16. A heat-treated resin molding according to claim 3, wherein the resin molding (W) is heat-treated so that rubber particles in the resin surface of the resin molding retain a circular shape of 2:3 or less in terms of a size ratio in longitudinal and transverse directions.

17. A heat-treated resin molding according to claim 5, wherein the resin molding (W) is heat-treated so that rubber particles in the resin surface of the resin molding retain a circular shape of 2:3 or less in terms of a size ratio in longitudinal and transverse directions.

18. A heat-treated resin molding according to claim 15, wherein the resin molding (W) is heat-treated so that rubber particles in the resin surface of the resin molding retain a circular shape of 2:3 or less in terms of a size ratio in longitudinal and transverse directions.

19. A heat-treated resin molding according to claim 3, wherein the resin molding (W) to be partially heat-treated at a high temperature is a resin molding produced by molding in an injection molding machine.

20. A resin molding heat-treating apparatus according to claim 9, wherein a shield plate (8) having an opening portion (7) of a shape conforming to the contour line of the portion to be heated of the resin molding (W) is disposed in a sandwiching relation to the heating section (2) so that the other portion than the portion to be heated of the resin molding (W) is not heated.
